(19) United States
(12) Patent Application Publication
(10) Pub. No.: US 2013/0103500 A1
(43) Pub. Date: Apr. 25, 2013

(54) ONLINE PROMOTIONAL TOOL

(71) Applicants: William J. Veeneman, Hudson, WI (US); Kathleen M. Veeneman, Tempe, AZ (US); James R. Mirick, Chaska, MN (US)

(72) Inventors: William J. Veeneman, Hudson, WI (US); Kathleen M. Veeneman, Tempe, AZ (US); James R. Mirick, Chaska, MN (US)

(21) Appl. No.: 13/488,096

(22) Filed: Jun. 4, 2012

Related U.S. Application Data
(60) Provisional application No. 61/493,185, filed on Jun. 3, 2011.

(51) Int. Cl. G06Q 30/02

(52) U.S. Cl. CPC G06Q 30/0259
USPC 705/14.57

(57) ABSTRACT

An Internet-based marketing service. Embodiments link local businesses with local consumers while at the same time supporting local causes by promoting patronage of local businesses and/or purchase of manufacturer's products. Searchable landing pages containing detailed listing data and geographically-based social networking links can be included. Search results can be returned in several different, searchable forms. Other features may include an interactive map with participating cities and businesses, multiple mailing group signups in a single page, and a secure access code feature enabling purchase tracking. Cause marketing services provides hyperlocal coupons linked to charitable giving, as well as the related data from such coupon use. The cause marketing service enables manufacturers to donate once specific purchase targets are reached, with the proof of purchase electronically encoded on the coupon and recorded by the marketing service.

### RELATED APPLICATION

The present application claims the benefit of U.S. Provisional Application No. 61/493,185, entitled ONLINE PROMOTIONAL TOOL, filed Jun. 3, 2011, which is incorporated herein in its entirety by reference.

### FIELD OF THE INVENTION

The present invention relates generally to Internet-based marketing services. More specifically, the present invention relates to marketing and advertising services that link local businesses to local consumers while supporting local causes.

### BACKGROUND OF THE INVENTION

With the recent growth of the Internet, consumers have changed the way they shop. Recent statistics suggest that the Internet has become a key resource for consumers. For example, 78% of women plan their shopping on the web. Further, 68% of shoppers say promotions spur visits to stores. Additionally, 60% of shoppers look for coupons before shopping. Likewise, businesses have changed the way they market to these now-online consumers. Most businesses use the Internet in some capacity to market, sell, or otherwise interact with consumers. And, in some fields, maintaining an online presence is almost a necessity. However, because of some obstacles such as the cost, technology, and marketing expertise required, online marketing can be prohibitively expensive for small, local businesses to enter the online marketing fray.

Internet websites are housed on computers connected to the Internet. Thus, an initial cost required of businesses wishing to maintain an online presence is the cost of computers, operating software, networking equipment, and resources to manage the equipment that will house the business' website. This cost is often much more than a small business can afford.

Similarly, the burden of knowing and mastering the Internet technologies or protocols required to create dynamic and engaging yet simple websites is a severe obstacle to businesses wishing to maintain an online presence. Moreover, the increased prevalence of advertising and direct communication with consumers through social media, email or through mobile phones presents an additional hurdle to businesses attempting to remain current with the changing advertising world. Such businesses would either need to learn these technologies themselves—often outside of their area of expertise—or hire someone that already knows the technologies. Neither option is desirable for most businesses. The burdens of learning a technology can prevent business owners from concentrating on their strengths—selling their products or services, and the costs of hiring an expert in Internet programming is often cost prohibitive.

Small businesses wishing to maintain an online presence must also master the intricacies of online marketing in order to be successful in their online efforts. Again, this would require independent study and research of which marketing tools do and do not work, or incur the cost of hiring of an expensive expert in online marketing. Both options are undesirable for the same reasons as described in the Internet technologies problem above. Learning marketing techniques takes away from the business owners' core strengths of selling their products or services, and hiring an expert can be cost prohibitive.

Moreover, because of the inherent unruliness of the Internet, consumers looking for information relating to potential purchases are presented with numerous obstacles to overcome before they can gain access to the information they desire. For example, a consumer would need to know the precise name and location of every potential local business in which a product they might be seeking is carried. This is onerous on consumers and unhelpful to businesses of already meager marketing means. After establishing a list of desired stores, consumers would need to subsequently visit every store's individual website. In doing so, they will undoubtedly be confronted with myriad of different website interfaces. This requires consumers to learn each store's website interface, method of categorization and structure. Additionally, consumers are often unable to quickly search by any meaningful feature or category, or save various preferences or bookmarked items without doing so on each store's website. These burdens cost consumers their valuable time and resources.

Additionally, existing Internet geographic search and retrieval services consider only the formal geography, e.g. city name or zip code, when presenting the located businesses, which makes highlighting the locality of shopping opportunities. For example, a search of merchants that sell “widgets” in “City A” would only return that stores X, Y, Z in City A that sell widgets, without mentioning stores 1, 2, 3 located in adjoining City B that also sell widgets, but may be relatively closer to the consumer despite the city boundary. A second search of stores that sell widgets in City B would be required of the consumer to find these stores. This is a problem for both merchants, who are not linked to nearby consumers, as well as consumers, who undoubtedly need to expend more resources (time, driving distance) finding their desired products.

Thus, there is a need for a streamlined, inexpensive method for local businesses to connect with local consumers via an Internet-based marketing service that houses numerous local stores' websites in a single uniquely identifiable location.

### SUMMARY OF THE INVENTION

An Internet-based marketing service according to embodiments of the present application substantially meets the aforementioned needs of the industry. The service according to embodiments of the invention is designed to tightly link online marketing to drive consumers to local business via the internet while at the same time strengthening the local community. The service generally comprises an interactive website housed on a server that is connected to the Internet. The service thus provides an online micro-marketing opportunity for local businesses that utilizes the global reach of the Internet.

The service provides for a dedicated community website for every participating community. Furthermore, a participating community can be defined in a variety of ways that may transcend or combine typical geographical boundaries, such as by the boundaries of a school district. Participating businesses within the participating community would then be able to utilize the service's streamlined search function that targets local customers. By engaging with local customers via a global service, local businesses working together in a common marketing platform get the same visibility and marketing resources as national chains. Moreover, local businesses can then exploit fast-changing technology, including mobile coupons and social networking at a low cost and a low learning curve to them.

Consumers, including local residents and website visitors, gain one-click access to all relevant local store information, including coupons and event details. In addition, customers are able to search by more standardized search characteristics or categories to gather shopping information. Additionally, consumers are able to acquire businesses' coupons or offers via the website. Ultimately, local consumers are able to maximize their time and resources by utilizing the service and the unique information it provides. Customers can also be attracted to businesses or offers from or by a select group of businesses or manufacturers because they can benefit a uniquely defined unit such as a neighborhood unit or a school district.

In one aspect of the present invention, the marketing tool further comprises the ability to define communities based on virtual boundaries, rather than strict geographic boundaries. For example, most existing community-targeted marketing services are limited to the geographic boundaries set by civic officials. However, businesses and consumers often associate with a community within a specific geographic boundary that is similar than or larger than set civil boundaries such as a club or a school district may specify. As such, it is clearly beneficial to allow these communities to be defined and subsequently, have the appropriate consumers targeted. For example, a “university” community as well as a traditional “local resident” community may coexist within the same geographic boundaries. The hosting organization can appropriately define these boundaries, as each community will differ. Further, multi-community boundaries are possible, whereby a “community” spans multiple geographic borders.

The service utilizes community-directed advertising, which drives local traffic to participating businesses by promoting participating businesses through a community-centric search engine that leverages ease of access and awareness of a single site that hosts all participating businesses. In addition, the service's community-directed advertising provides visibility to business listings with a variety of marketing tools, like sponsoring civic institutions, communicating to their members of the community to shop at participating businesses, ongoing search engine optimization, enabling school fundraising by selling downloadable access cards and coupons for local businesses, emailing offers from participating businesses to all community residents who sign up with an email address, providing a membership badge to display in the store and on the website of each participating store, thus subsequently strengthening the community connection, donating funds to local civic and educational programs in exchange for promoting the participating businesses, establishing a local and consistent presence on various social networks, and distributing business information and coupons to local residents' home computer, cell phone, or by other means.

The community-directed advertising can be used to provide marketing services for charitable organizations in addition to retailers by providing hyperlocal coupons linked to charitable giving. Historically, marketers have utilized charitable giving as both a benefit to the respective donated-to organization as well as publicity for the donor. Once a community or local-level service network is structured as discussed above, the value of pointedly targeting coupons to community or local-level consumers and subsequently linking them to local causes is readily apparent.

In an embodiment of the present invention, a donation amount and charity are tied to a specific coupon or offer, as defined by a merchant or business. In another embodiment, the donation amount and charity can be dynamically changed by the user or merchant. For example, a business may show increased sales because of a particular donation amount or because of a particular charity. Thus, important cause marketing data is generated. Varying donation amount and cause data can then be utilized by the merchants and businesses to make future business decisions. Because this data is reported at such a granular level as compared to traditional charitable giving, businesses are able to make business decisions at increasingly detailed levels. The data may also be accumulated or aggregated to illustrate more “macro” trends.

Because the service tailors at a local level, the present invention is able to organize local gifting, a field that has traditionally been characterized as disparate and unorganized. In the service of the present invention, charitable contributions become organized at the local level by increasing the visibility for both local businesses and local charities. The infrastructure provided by the service further allows for the recordation of giving and receiving of donations for local charities, local businesses, and local independent donors. Users may “register” with the service to have their coupons and donations automatically recorded. Further, once registered, users can specify their preferred charitable choices, like donation amount or organization.

A key feature of the service is the searchable landing pages for local businesses. Each business is given an individual searchable webpage containing that business' detailed listing data. In essence, the landing page acts as the business' online presence in the absence of its own independent website. These landing pages provide external search-engine visibility for database-driven business listings and coupons such that if someone on an external search engine searches for one of the businesses, the engine will return the service's coupon-result page. The landing page contains meta content tags to ensure that the merchant name and other key business-related terms are active for the external search engine.

Another feature and advantage of the present invention allows merchants and manufacturers to donate to specific charitable organizations once specific purchase targets are reached without the burden to consumers of proving the purchase target. For example, if a particular manufacturer wishes to donate to a charity once 50 coupons are redeemed; such information can be encoded electronically on the individual coupons and within the system. Because each individual coupon's use is recorded by the system of the present invention, once the use of 50 coupons is reached, the donation can automatically be effected. In such an embodiment, the days of consumers collecting “proofs of purchase” or soup can labels and mailing them in as proof of a purchase target are over.

Another feature of the service is the utilization of existing social media in the form of the “Like” and “Follow” features. After a consumer has placed a search on the service, the website gives the searching consumer the ability to “follow” the service's geographically-specific Facebook and/or Twitter accounts. This creates a geographic connection between the consumer and an extension of the service in the form of social media such that the service is able to actively update or post to the consumer future marketing related to the consumer's specific location.

Another feature of the service is the ability to return search results in many different forms. For example, the service can format return result lists for specific communities, local stores in a specific geographic location, and cities with participating stores, among others. Further, the search result listings can be sorted, including by newness, relative distance, age appropriateness, category, or alphabetical store name, among others. This is of great use to the consumer, who can then make purchasing decisions based on this unique information.

With the flexibility of the aforementioned search, merchants can be included in search results in a city as formally defined per their address, included within a locale or neighborhood within a city or region, which may be only informally defined or identified or may be ad-hoc, and/or included in a larger region or market area, which may be informally defined or identified. Likewise, consumers can then find merchants' offers and coupons through geographic searches at several levels of specificity, from neighborhood up through regions, find offers and coupons related to local events and festivals, and further refine searches for types of items or age-appropriateness.

Another feature of the service is an interactive map that details participating geographic locations and the associated businesses. The map allows for state and regional zooming so that specific geographic areas can be viewed. Such a feature is valuable not only to consumers who live in a certain location, but those who may be traveling to that location as well. Purchasing or travel decisions can then be made with this information.

Another feature of the service is the ability of the consumer to sign up for multiple mailing groups in a single sign-up page. This data is stored in a database such that queries can operate on the inputted data to uniquely identify the different emails that should be sent to the consumer.

Another feature of the service is the GO MAX CARD (GMC) program. GMC enables local businesses to geographically target their offers to the local community and to change the offers as often as business needs dictate. Likewise, consumers utilizing the GMC program gain the benefit of knowledge of the latest offers as dictated by the freshness of merchants' inventory. The program operates in a cycle of assembling merchants and offers, selling and distributing cards or participant ID codes to the consumer, the consumer acquiring coupons and subsequently purchasing items, and GMC tracking and analyzing participation and effectiveness.

Core to the GMC program is the issuance of secure access codes that, when entered on the GMC system, provide code owners access to special coupons and other offers that are contained within a secure web site. The special codes can be acquired by, for example, in certain embodiments, signing up online or by purchasing a card. For each code acquisition, a fee is charged that is paid to the sponsoring institution who is engaged in fundraising by promoting the program. Therefore, secure access codes can issue to each merchant, group, or organization to track and report its sales. Assigned codes can allow for varying levels of authentication for sale and use, such that certain codes can allow access to local businesses and other codes can allow for broader access, such as to regional or national businesses. Codes can be issued in a variety of ways, from online, to text codes on mobile devices, email, and print. In one embodiment, the acquirer of the code is invited to go to the program web site and enter their personal email address, zip code, password or other secure information to activate their account. Personalizing also establishes what level of service the consumer purchased in terms of access to broader geographic areas of the program. Furthermore, in one embodiment, issuance of the codes is through a set of printed cards that can be distributed to the organization members for the purpose of selling and purchasing such cards. In other embodiments, the offers or codes may be distributed via other printed materials or digitally on an electronic device.

A major benefit of the GMC program is the utilization of program use tracking. Because each secure access code acquirer is requested to “personalize” the access code they have acquired, the program can utilize this information and tailor offers to each member of a specified community. Use of all access codes is reported to the issuing institution to track against reported sales. Further, once a code is personalized, the GMC program can track use when, for example in one embodiment, the acquirer logs into the website to learn of the offers and coupons available and to then obtain those offers if desired.

Detailed, product-level, consumer-level, and merchant-level tracking is also available through the GMC program. As each offer/coupon is selected by a consumer, the system automatically encodes the offer to track its use. This tracking can capture who, when, and what offer is selected and the participating business at which it is used. Further, tracking can be itemized down to the individual item purchased. Additionally, each offer/coupon can have information on the acquirer, the sponsoring institution who sold the program, merchant identification, and offer, date, and delivery type—digital, print, etc. In another embodiment, the program offers the incentive of a second reward for the personalization of the offer to the acquirer in which the offer is collected at the point of sale and returned GMC for additional reward to the participating institution. As a result, the participating consumer can be given a personal incentive or enrolled in a particular contest.

From a merchant perspective, GMC offers a highly flexible system in which merchants are able to continually adjust their offerings. In one embodiment, the system counts and limits the number of offers printed or accessed, sets a limited time expiration date based upon date accessed, limits the number of offers per acquirer code, sends special offers to the code user based upon the needs of the business, continuously changes offers based upon the marketing decisions of each business, and tracks and reports use, which can be reported by business, day, or user, among others.

From a consumer perspective, GMC provides for an opt-in communication service such that consumers can be on the cutting edge of merchant offers and communication. Further, consumers are kept well-informed of expiration dates and program terms.

The above summary of the invention is not intended to describe each illustrated embodiment or every implementation of the present invention. The detailed description and appendices that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a flowchart of system architecture, according to an embodiment.

FIG. 2 depicts a business landing page, according to an embodiment.

FIG. 3 depicts a search results page having a plurality of business landing pages, according to an embodiment.

FIG. 4A is a flowchart of a method of marketing utilizing a marketing artifact, according to an embodiment.

FIG. 4B is a detailed flowchart of a portion of the elements of FIG. 4A, according to an embodiment.

FIG. 5 is a flowchart of a method of marketing using cards, according to an embodiment.

FIG. 6 is a flowchart of a method of marketing, according to an embodiment.

FIG. 7 is a flowchart of a method of marketing, according to an embodiment.

FIG. 8 is a representative schematic diagram illustrating the linking of charitable organizations and retailers through a marking tool, according to an embodiment of the present invention, to provide promotions linked to charitable giving.

FIG. 9 is a representative schematic diagram illustrating the selection and redemption of promotions linked to charitable giving by consumers through the marketing tool depicted in FIG. 8.

FIG. 10 is a representative schematic diagram illustrating the interaction between retailers and charitable organizations through the marketing tool depicted in FIG. 8 following redemption of promotions linked to charitable giving as depicted in FIG. 7.

FIG. 11 is a representative web page image depicting representative search results for local retailers or manufacturers providing by a marketing tool according to an embodiment of the present invention.

FIG. 12 is a representative web page image depicting a representative promotional page providing detailed information on a promotion from a local retailer or manufacturer is selected from the search results depicted in FIG. 11.

FIG. 13 is a representative web page image depicting a promotional page illustrating a promotion launch page from which a user can individualize the selected promotion.

FIG. 14 is a representative web page image illustrating a drop down menu that is created when a consumer selects the promotion on the promotional page depicted in FIG. 13 and providing a list of geographically pertinent charitable organizations that can be linked to the redemption of the promotion.

FIG. 15 is a representative image of coupon created when the consumer selects the promotion on the promotional page depicted in FIG. 13 and selects a charitable organization depicted in FIG. 14.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

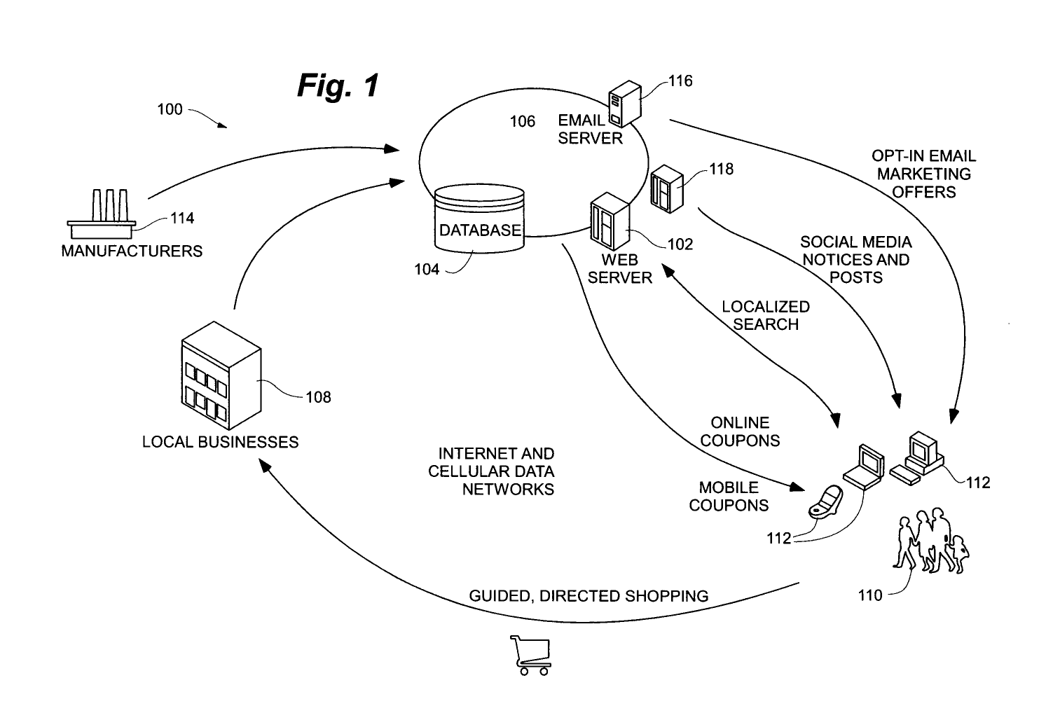

Embodiments relate to systems and methods for community-directed marketing for promoting the offerings of businesses. Referring to FIG. 1, marketing system 100 is depicted. Embodiments of marketing system 100 generally include server 102, database 104, network 106, businesses 108, and access by users 110 via devices 112. Optionally, marketing system 100 can include manufacturers 114, email server 116, and social media interface server 118.

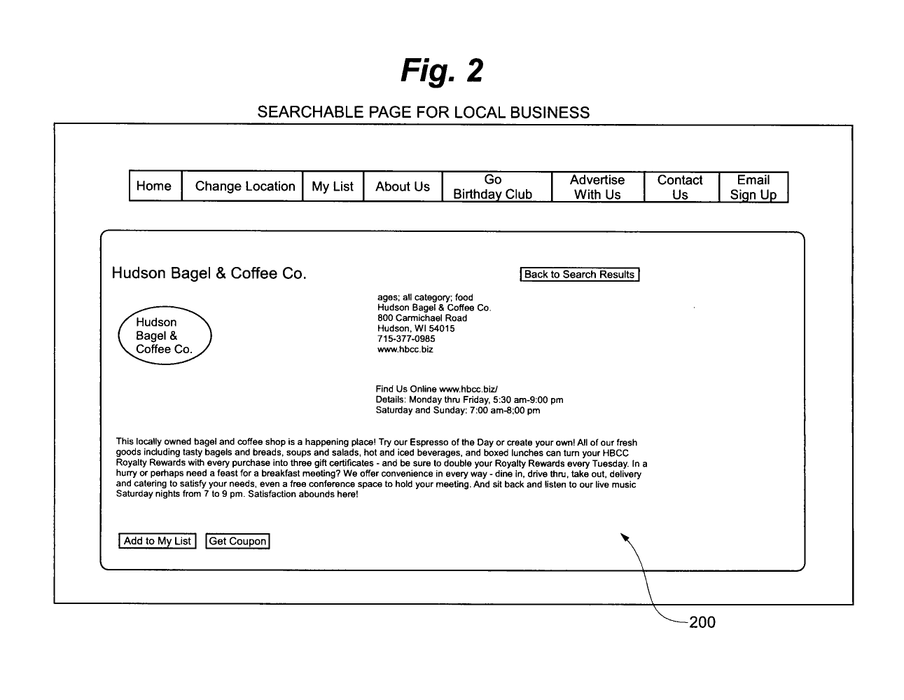

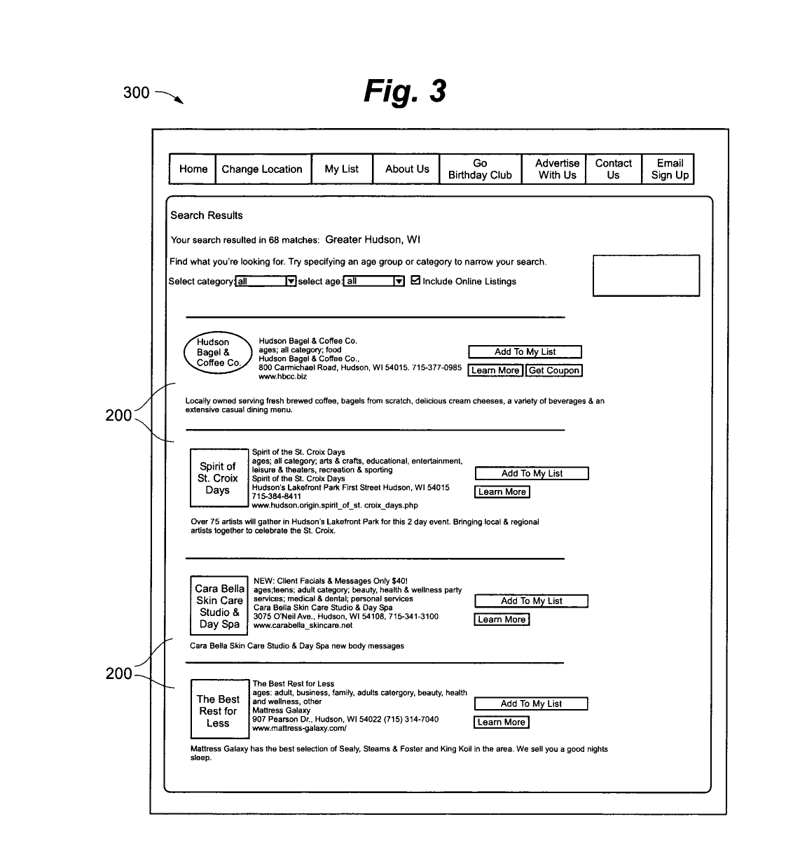

Server 102, in an embodiment, comprises a processor having non-transitory memory coupled to the processor. The processor is configured to access and store data in database 104, as well as to receive data from businesses 108 and manufacturers 114, as well as users 110. As depicted, the data can be transmitted and received along network 106, as will be described. Non-transitory memory allows the processor to run the appropriate algorithms. In an embodiment, server 102 is a web server allowing for the display of various web pages to users 110. In an embodiment, the web page can be a landing page for each of the plurality of businesses, as depicted in FIGS. 2-3.

Referring again to FIG. 1, database 104 can be any kind of organized collection of data. Database 104 is configured to store data related to the plurality of businesses as well as related to users 110. The data can therefore be business name data, sale offering data, coupon data, as well as demographic, social, or economic information of the user, for example. Data can also be related to various transactional data such as transacting user, delivery type, selling institution, or offer executed, for example. In an embodiment, database 104 is housed within server 102. In another embodiment, database 104 is accessible to server 102 along network 106.

Network 106 is any collection of appropriately linked hardware and software components configured to transport data. For example, in embodiments, network 106 can be a wired twisted pair, coaxial cable, Ethernet, or optical fiber network. In other embodiments, network 106 can be a wireless network such as a wireless LAN or cellular network. Network 106 operably couples the processor of server 102 with users 110 such that the network is accessible by users 110 to transmit and receive data. In an embodiment, network 106 operably couples server 102 with database 104. Additionally, businesses 108 and/or manufacturers 114 are coupled to server 102 via network 106. In the optional embodiments having email server 116 and social media server 118, network 106 is further configured to connect these components with server 102 and users 110, as depicted in FIG. 1

By agreeing to market using marketing system 100, businesses 108 are coupled to network 106 and thus system 100. Businesses 108 are coupled to network 106, and thereby server 102, in order to transmit and receive business, transaction, and user data. Business data is transmitted to network 106 from businesses 108 for storage by database 104. Likewise, transaction and user data can be transmitted to businesses 108 from server 102 along network 106 for use in marketing.

Users 110 typically comprise the customers or potential customers of businesses 108. Users 110 access network 106 via devices 112. Devices 112 are any electronic computing device capable of accessing data. For example, devices 112 can comprise a cell phone, laptop computer, desktop computer, tablet, or any other suitable device. In an embodiment, users 110, via devices 112, access web pages presented by server 102 related to data of businesses 108. Users 110, via devices 112, are also capable of transmitting user-defined preferences to server 102. For example, an individual user 110 can transmit a user-defined area in which the user 110 patronizes businesses 108. In sum, guided, direct shopping is a goal of users 110 via system 100.

In embodiments, manufacturers 114 access network 106 and thereby server 102 similar to businesses 108. In embodiments, email server 116 provides directed email services to users 110 as part of marketing system 100. In embodiments, social media server 118 provides social media services to users 110 as part of marketing system 100.

Referring to FIG. 2, a business landing page 200 is depicted, according to an embodiment. In an embodiment, as depicted, an individual searchable landing page is a real or dynamically-generated presentation of data in a web browser or other electronic delivery application. Business landing page 200 is an individual searchable webpage containing an individual business' detailed listing data. The detailed listing data can include the name of the business, the location, phone number, business website, hours, logo, business description, sale or offer data, or coupon data, for example. Effectively, landing page 200 acts as the business'online presence in the absence of its own independent website. Landing pages 200 provide external search-engine visibility for database-driven business listings. In an embodiment, landing page 200 contains meta content tags to ensure that the merchant name and other key business-related terms are active for an external search engine.

Referring to FIG. 3, a search results page 300 having a plurality of business landing pages 200 is depicted, according to an embodiment. Landing pages 200 for multiple businesses are presented to the user in a single web page, as depicted in FIG. 3. In operation, a user 110 defines an area in which to search for businesses. The area in which the user wishes to search is relayed to server 102. Server 102 utilizes its processor and coupled non-transitory memory to interface with database 104, such that the appropriate data is retrieved from database 104. Database 104 data is formatted and displayed in search results page 300. Search results page 300 is thus displayed to user 110.

In an embodiment, the user-defined area is a geographic area. The geographic area could be as elementary as a city, town, or county. However, the geographic area is more effectively defined as a sub-community of the city, town, or county that doesn't have discrete boundary lines; for example, a neighborhood or school district within a city or a group of cities. In an embodiment, user 110 can stipulate business categories or product categories to further refine the search. In embodiments, the user-defined area is scalable to return greater or fewer search results, depending on the scale of the searched area. Further, because the user-defined areas are most effectively defined along non-traditional boundaries, businesses can belong to multiple areas.

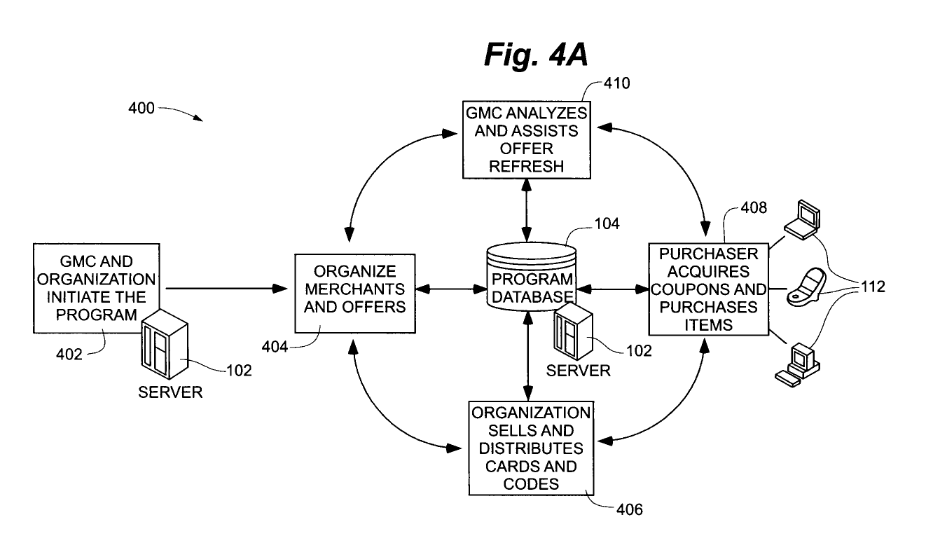

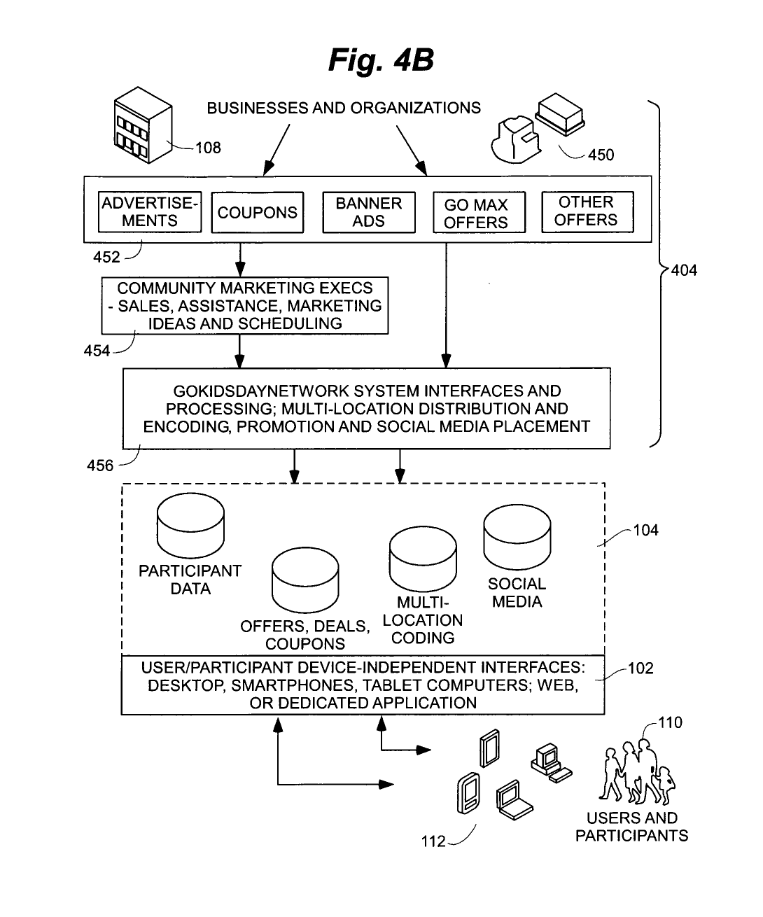

Referring to FIG. 4A, a flowchart of a method of marketing 400 utilizing a marketing artifact is depicted, according to an embodiment. At 402, the method is initiated. In an embodiment and as depicted in FIG. 4A, initialization is done through the accessing of server 102 with an appropriate program registration request. For example, a school, here the selling organization, may request from server 102 that the marketing program be set up for their school.

Merchants and offers are organized by, in an embodiment, marketing system 100, at 404. As described above with respect to marketing system 100, business data can be assembled from businesses 108, in an embodiment. Referring to FIG. 4B, a detailed flowchart of the operation of 404 and the relation to the other elements of FIG. 4A is further depicted.

Businesses 108 and organizations 450 are organized at 404, depicted as a portion of FIG. 4B. Advertisements, coupons, banner advertisements, marketing offers, and other offers of 452 are all tools provided to businesses 108 and organizations 450 desiring marketing services. Community marketing executives of 454 provide sales, marketing, scheduling, and other assistance to the businesses 108 and organization 450 utilizing the tools of 452. The coordination of the services provided at 454 and the tools of 452 are implemented at 456. This can include, for example, interfacing with the system, such as the landing pages 200 described above, multi-location distribution and encoding, promotion, and social media placement.

The implemented tools and accompanying data of 456 are relayed to database 104. In an embodiment, database 104 can be as depicted in FIG. 4B, as a plurality of discrete databases. For example, discrete databases can be configured to store, respectively, participant data, offers, deals, and coupon data, multi-location coding data, and social media data. In another embodiment, a single database 104 is configured to store all participant data, offers, deals, and coupon data, multi-location coding data, and social media data. Similarly, server 102 or a plurality of similar servers 102 provide the user or participant device-independent interfaces to the aforementioned data. As in FIG. 1 and as will be described further in FIG. 4A, the data is accessible to users 110 via devices 112.

Referring again to FIG. 4A, at 406, the selling organization sells and distributes the marketing artifacts set up as part of the marketing program for their respective organization. In an embodiment, the marketing artifact can be a card. In another embodiment, the card can be virtual and accessed via a computer or other electronic device. In another embodiment, the marketing artifact is an access code.

At 408, devices 112 allow users 110 who have purchased cards, codes, or other marketing artifacts, to acquire coupons and purchase items from merchants providing offers as part of 404. These coupons and offers for sale are only available to users 110 who have purchased the artifacts of 406.

At 410, transaction data is analyzed based on the available offers of 404 and executed transactions of 408. At 410, offer refresh is offered to the participating respective merchants such that inventory offers remain fresh and locally appropriate. Any refreshed or changed offers are thus transmitted to users 110 via devices 112, and can be subsequently purchased at 408.

As depicted, the elements of 404, 406, 408, and 410 are interfaceable with the respective neighboring element in order to provide a flexible, useful method of marketing 400. For example, the number and type of merchants and offers that are available as organized at 404 are interfaced to the selling organization at 406 in order to appropriately sell the marketing artifacts.

As appropriate, the elements 404, 406, 408, and 410 interface with server 102 and database 104 when needed. In embodiments, server 102 and database 104 are, as depicted, the server and database of FIG. 1 in marketing system 100. In other embodiments, server 102 and database 104 can be independent, discrete servers and databases.

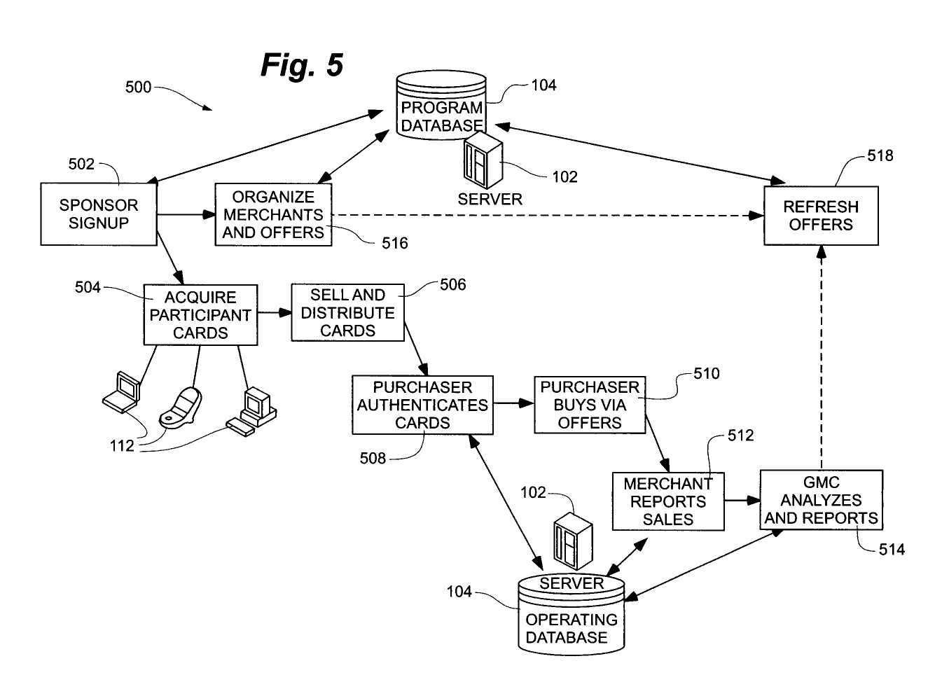

Referring to FIG. 5, a flowchart of a method of marketing 500 using cards is depicted, according to an embodiment. At 502, a sponsor signs up in order to initiate the method 500. The sponsor signup at 502 is interfaced with server 102 and database 104.

At 504, participant cards are acquired by the sponsor. Such acquisition can be by access devices 112, as depicted in FIG. 5. In an embodiment, the card can be virtual and accessed via a computer or other electronic device. In another embodiment, the marketing artifact is an access code. In other embodiments, the marketing artifact is a physical card.

Concurrent with or prior to the sponsor acquiring participant cards at 504, merchants and offers are organized at 516. Merchant and offer data transmitted to server 102 and database 104.

At 506, the cards are sold and distributed. Cards are typically sold by representative members of the sponsoring institution of 502. Card purchasers will typically buy the cards for not only the promised offers for sale by the organized merchants of 516, but for the charitable benefit to the sponsoring institution.

At 508, the card purchaser authenticates the card. Typically, this is done via an interface to server 102 and database 104. In an embodiment, the card purchaser is invited to go to the system web site and enter their personal email address, zip code, password or other secure information to activate their account. Personalizing also establishes what level of service the consumer purchased in terms of access to broader geographic areas of the program.

At 510, the card purchaser buys via one or more offers provided to them. In various embodiments, the card purchaser buys from multiple merchants. Multiple card purchasers can thereby purchase from multiple merchants.

At 512, the selling merchant reports sales to server 102, which is subsequently stored in database 104. The reporting of sales at 512 is attached with information such as the card purchaser, sponsoring institution, merchant identification, and offer, sale, and delivery type, for example.

At 514, this sales and transaction data is accessed from database 104 via server 102. At 514, the data can be aggregated, analyzed, or otherwise summed or evaluated.

Via interface 518, dynamically-refreshing offers can be initiated and implemented by participating merchants. After the analyzing and reporting of 514, such data or reports are transmitted to merchants in order to refresh the published offers. With this data, businesses can continually calibrate their offerings. For example, the number of offers printed or accessed can be counted in order to limit future offers. Or, a limited time expiration date based on the date accessed by card purchasers can be implemented. Alternatively, the offer can be changed based on the needs or desires of the business. As depicted via 516, 518, and 514, this refreshing of offers can be initiated solely by the merchant via server 102 and database 104, without input or evaluation from the hosting system.

In embodiments, server 102 and database 104 are, as depicted, the server and database of FIG. 1 in marketing system 100. In other embodiments, server 102 and database 104 can be independent, discrete servers and databases.

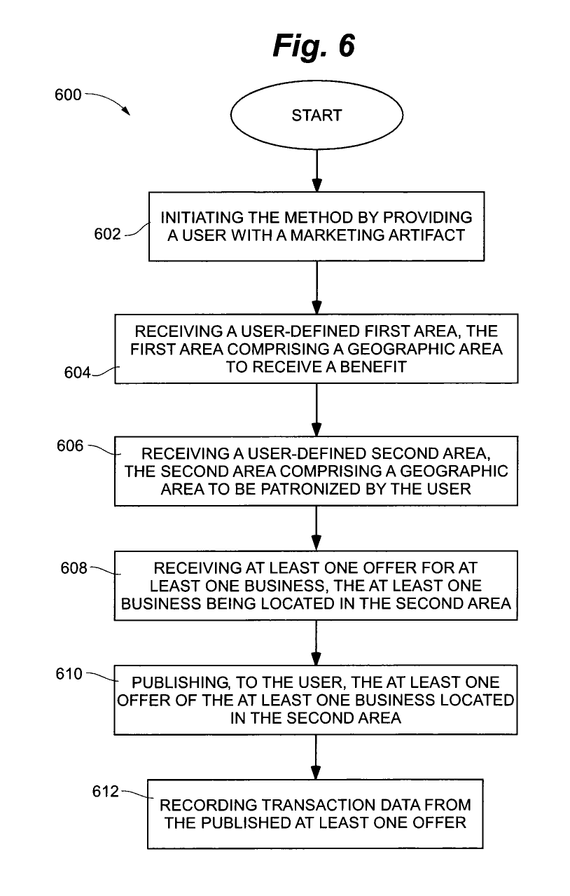

Referring to FIG. 6, a method 600 of providing community-directed marketing is depicted as a flowchart, according to an embodiment.

At 602, method 600 is initiated by providing a user with a marketing artifact. In an embodiment, the marketing artifact can be a card and initiating the method is through a sale of the card by a selling institution. In another embodiment, the card can be virtual and accessed via a computer or other electronic device. In another embodiment, the marketing artifact is an access code.

At 604, a user-defined first area is received. The first area comprises a geographic area to receive a benefit. Such a benefit can be the amount of the sale of the card, for example.

At 606, a user-defined second area is received. The second area comprises a geographic area to be patronized by the user. Such an area will have stores and businesses the user will subsequently shop at. Note that both first and second geographic areas are user-defined, which allows for flexibility in the method 600 for both the user and the distributer of the marketing artifact; for example, the selling institution, in an embodiment. Further, the first area and the second area can comprise the same area or overlapping areas. This is a likely occurrence when, for example, the marketing artifact is sold by a school to a parent living in the same school district. The parent is likely to patronize the geographic area of the school district and also define the benefit to a school in the school district. In an embodiment, demographic, social, or economic information of the user can also be received in order to further tailor the marketing to the user.

At 608, at least one offer for at least one of the businesses is received, where the business is appropriately located in the second area, the patronizing area.

At 610, the at least one offer of the at least one business located in the second area is published to the user. In an embodiment, the publishing of 610 can be displaying the offer on the landing page of the business. In another embodiment, the publishing of 610 can be by pushing the offer to a mobile device of the user. Effectively, method 600 thereby offers published information related to offers of the at least one business, but does not provide a method of selling the offer itself.

At 612, transaction data from the published at least one offer is recorded. In embodiments, the transaction data can include user data, delivery type data, selling institution data, or offer data, as well as basic sale data. In an embodiment, a future offer can be limited based on the recorded transaction data. For example, if a merchant or business only wants 100 offers to be redeemed as defining an offer limit, the recorded transaction data can be checked against the number of offers redeemed. Subsequently, the offer can be removed once the offer limit is reached. In an embodiment, the recorded transaction data can be aggregated, summed, or otherwise combined and subsequently analyzed. In another embodiment, the analyzed transaction data or raw transaction data can be transmitted to the selling merchant or business.

In an embodiment, a second offer from the at least one business located in the second area is received. Subsequently, the second offer can be published. In another embodiment, the second offer is an update to the original offer. In this way, businesses can dynamically update their offerings without evaluation and action by the hosting system.

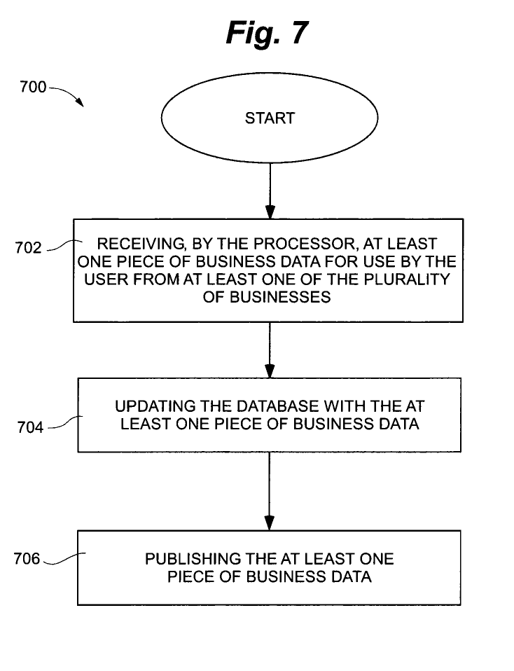

Referring to FIG. 7, a method 700 of dynamically generating advertising using a system for community-directed marketing is depicted as a flowchart. In an embodiment, method 700 is implemented by a system accessible by at least one user and includes a processor having non-transitory memory coupled to the processor, a database configured to store data related to the plurality of businesses, a network accessible by the user and operably coupling the processor with the database, and a landing page for each of the plurality of businesses, the landing page including a business name, wherein the processor is configured to receive a user-defined area, and to display the landing pages of businesses belonging to the area for the user based on the user-defined area and data stored in the database. Method 700 allows for businesses to dynamically update their offerings without evaluation and action by the hosting system. Effectively, this allows businesses to keep their inventory offers fresh and locally appropriate.

At 702, at least one piece of business data for use by the user from at least one of the plurality of businesses is received by the processor. The business data could include an offer for sale, or a coupon, or a new product offering, for example.

At 704, the database is updated with the at least one piece of business data previously received at 702. The processor transmits the appropriate commands to the database via the operably coupling network in order to store the business data.

At 706, the at least one piece of business data is published to the user. In an embodiment, publishing the at least one piece of business data can be displaying the at least one piece of business data on the landing page of the business. In another embodiment, publishing the at least one piece of business data can be pushing the at least one piece of business data to a mobile device of the user.

In an embodiment, prior to receiving the at least one piece of business data at 702, method 700 can prompt at least one of the plurality of businesses for business data. For example, prior to Valentine's Day, the system implementing method 700 can transmit a message or otherwise interface with one or more of the plurality of businesses and ask if any of the businesses would like to promote a Valentine's Day offer or coupon.

In an embodiment, method 700, as implemented by the above-described system, and specifically the portion interfacing with businesses to transmit business data (which is subsequently received at 702) is password protected. In this way, businesses have direct access to their respective landing pages and can therefore dynamically update their offerings without evaluation and action by the hosting system, as the data is trusted via the password protection. In other embodiments, other security keys or handshaking can be used.

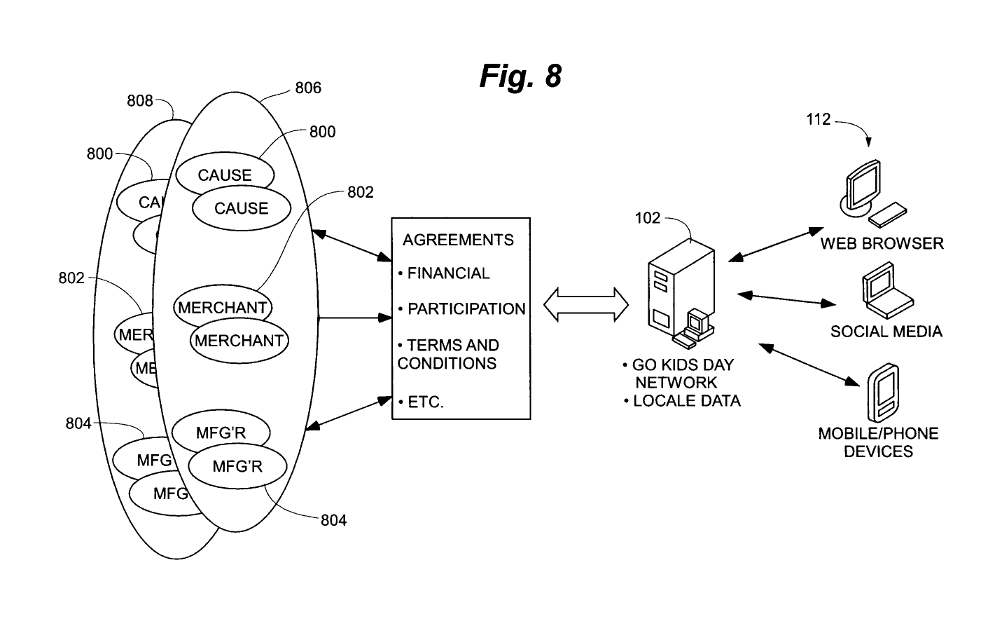

As shown in FIG. 8, the marketing system 100, in the embodiment of the present invention, can further comprise grouping charitable organizations or causes 800, merchants 802 and manufacturers 804 in at least a first market 806 and a second market 808. The respective markets 806, 808 can be accessed by the devices 112 through the server 102.

The entities 800, 802, 804 can be grouped into the markets 806, 808 according to communities in which the entities 800, 802, 804 are located. For the purposes of this application local merchants 802 and manufacturers 804 located in a market 806, 808 can correspond to merchants 802 and manufacturers 804 based in the market 806, 808 or sell products or provide services within the market 806, 808. In one aspect, the boundaries of the communities can be assigned virtually by the entities 800, 802, 804 or by the users 110 to define the community region according to non-conventional boundary, such as a smaller area surrounding an educational institution within a town or city. A conventional geographical boundary for the purposes of this application can comprise a city or town border, a zip code border, state border or even country border. In another aspect, the boundaries of the communities can be assigned virtually to include multiple areas ordinarily separated by a conventional geographical boundary such as a city, town or state boarder.

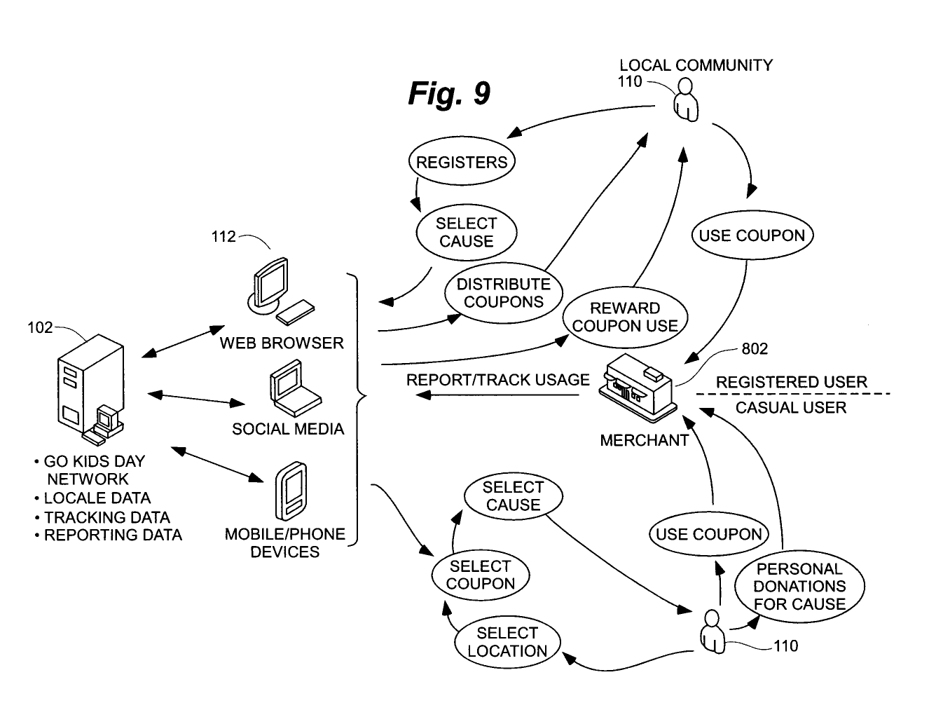

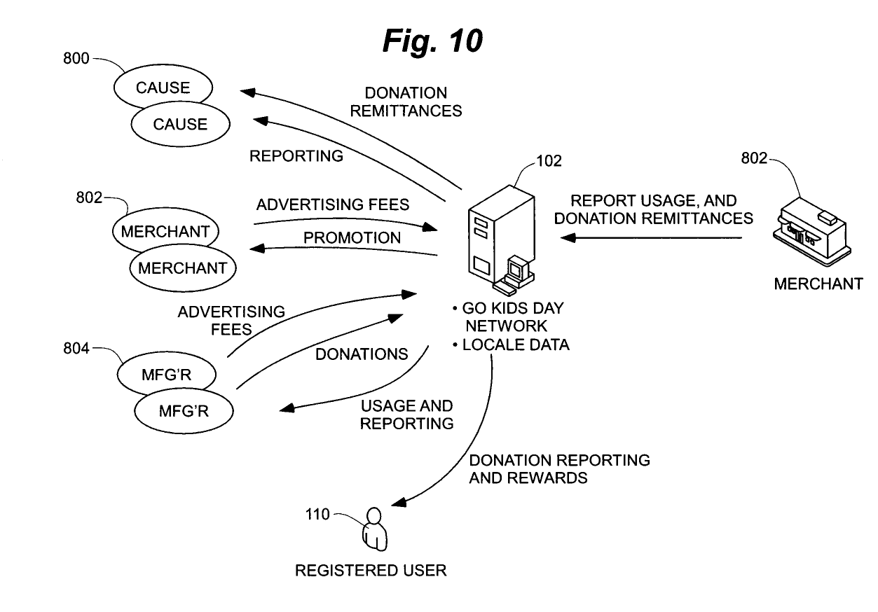

As shown in FIG. 9, in one embodiment of the present invention, the server 102 can facilitate, via device 112, the selection of a promotion for a merchant 802 or manufacturer 804 within the first or second market 806, 808 and the selection of a cause 800 in the corresponding market 806, 808. In one aspect, the merchant 802 or manufacturer 804 can provide a plurality of promotions where at least one of the promotions qualifies for a charitable donation to a selectable cause 800. The server 102 can provide a coupon to the user 110 for the selected merchant 802 or manufacturer 804 and that is linked to the selected cause 800. In one aspect, the server 102 can encode each coupon with a unique identifier that indicates the selected merchant 802 or manufacturer 804 and the selected cause 800. The server 102 is also adapted to receive a report when the coupon is used by the user 110 at the selected merchant 802. In one aspect, the unique identifier can be used to record and track the redemption of the promotion, user 102 and selected cause 802 at the point of sale at the merchant 802 or manufacturer 804. In one aspect, the user 102 can register on the system 100 to receive reward coupons for repeated use of the system to obtain promotions and/or charitable giving through the system 100. In another aspect, the user 102 can receive rewards and reports on their usage of the system, including charitable giving, through the system 100 as depicted in FIG. 10.

As shown in FIG. 10, according to an embodiment of the present invention, the server 102 can facilitate transactions between the system 100 and the cause 800, merchant 802 and the manufacturer 804 in response to a reported use of the coupon for the selected promotion and cause by the user 110 at the merchant 802 or manufacturer 804. In one aspect, the server 102 can provide the cause 800 with the donations earned from the use of the coupon as well as a report of the donations collected and distributed. In another aspect, the server 102 can collect advertising fees and organize promotions received from the merchant 802 as well as report on the usage of the provided promotions. Similarly, the server 102 can collect advertising fees and organize promotions received from the manufacturer 804 as well as report on the usage of the provided promotions. According to an embodiment of the present invention, server 102 can also report redemption of the coupon to the merchant 802 or manufacturer 804 to notify the merchant 802 or manufacturer 804 to provide the corresponding donation to the selected cause 800. In one aspect, the server 102 can track usage of the coupons by multiple users 110 and notify the merchant 802 or manufacturer 804 when a predetermined threshold for making the donation is met.

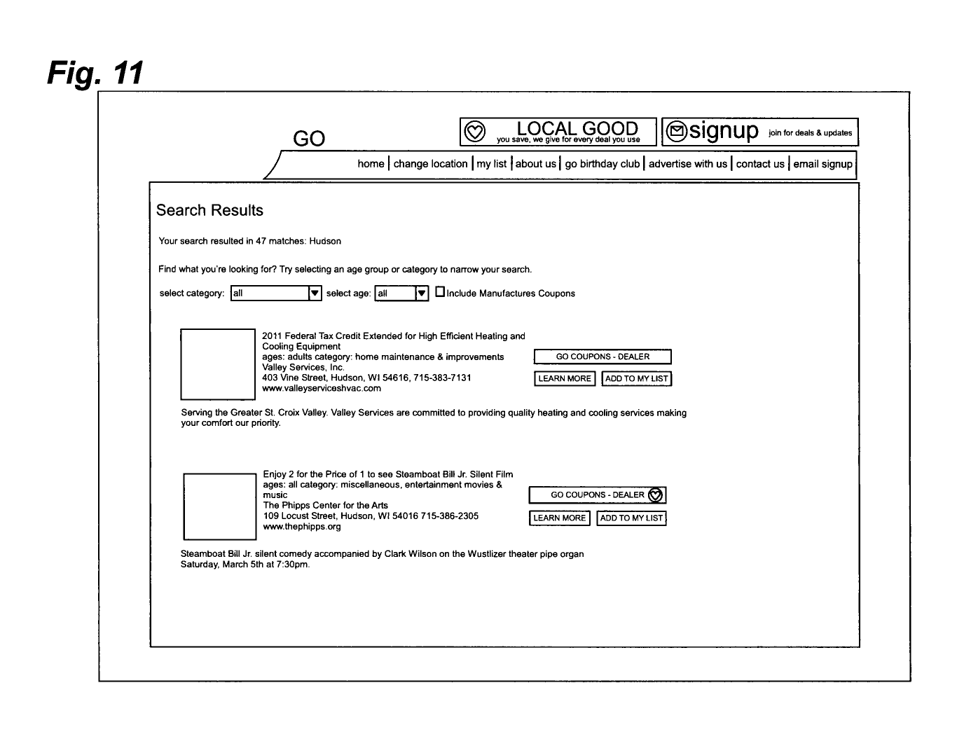

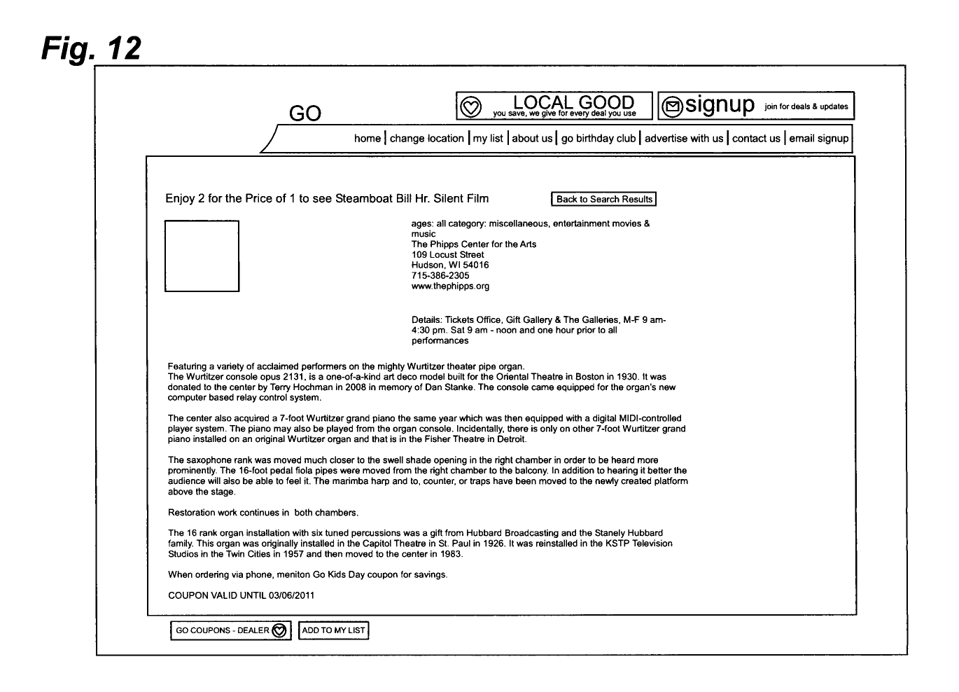

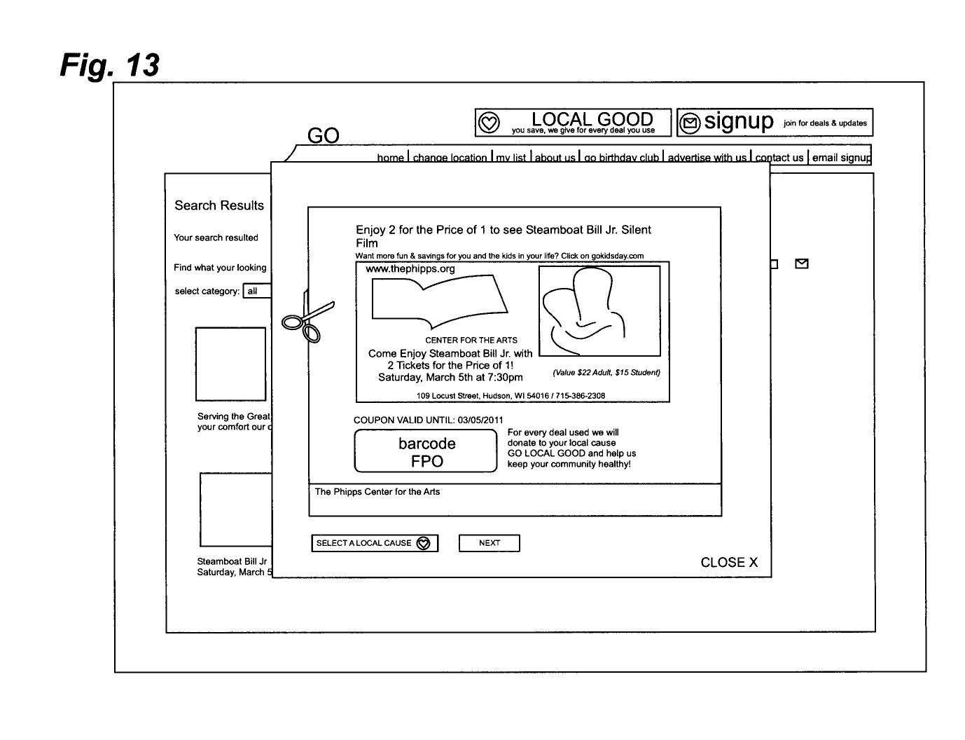

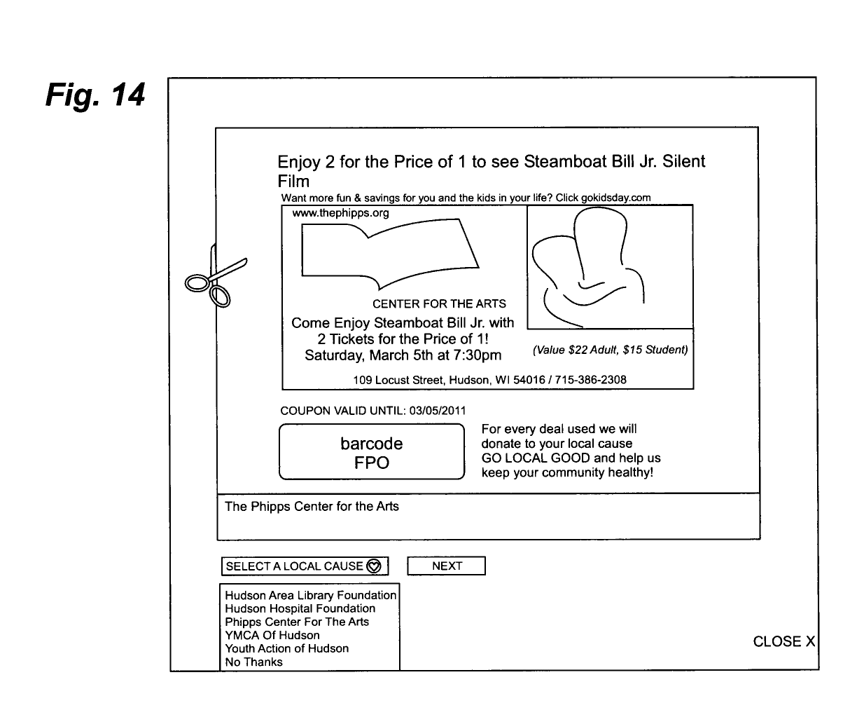

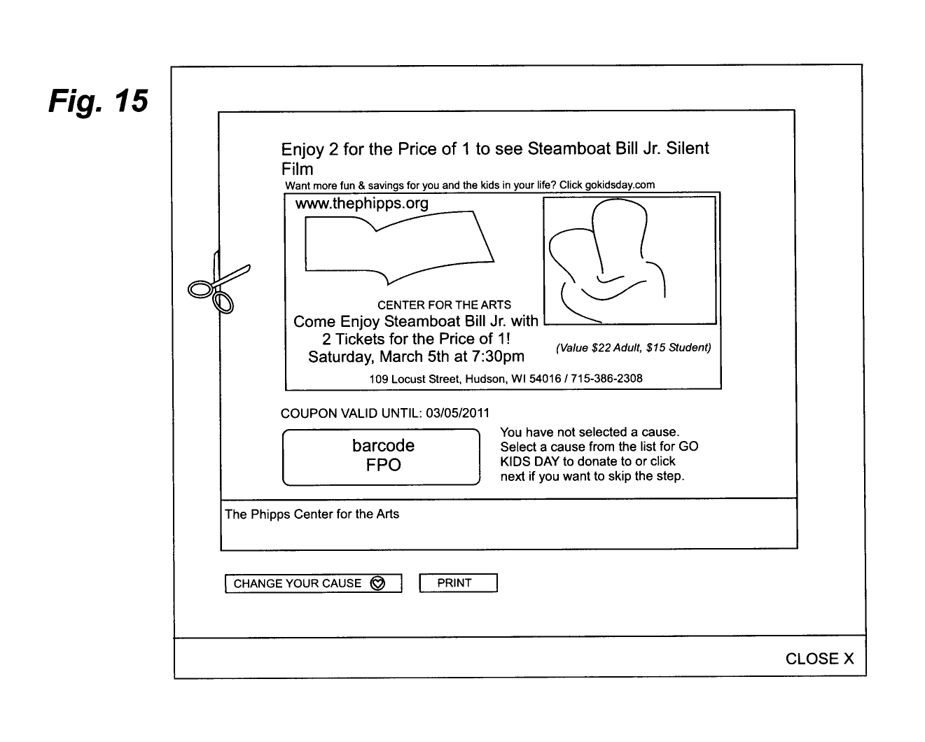

As shown in FIGS. 11-15, a method for providing a promotion linked to a local cause 800, according to an embodiment of the present invention, comprises providing a plurality of search results for local merchants 802 and manufacturers 804 in the first market 806. The method further comprises selecting the merchant 802 or manufacturer 804 and displaying at least one promotion for the selected merchant 802 or manufacturer 804. The method also comprises providing a list of causes 800 corresponding to the first market 806. In one embodiment, the method can comprise providing a plurality of promotions for the selected merchant 802 or manufacturer 804. In this configuration, the method can further comprise determining whether the promotion is eligible for charitable donations to a cause 800. The method further comprises selecting from the list of causes 800 to the link the selected cause 800 to the selected promotion. Finally, the method comprises providing a coupon corresponding to the selected promotion and selected cause.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

The invention may be embodied in other specific forms without departing from the essential attributes thereof; therefore, the illustrated embodiments should be considered in all respects as illustrative and not restrictive. The claims provided herein are to ensure adequacy of the present application for establishing foreign priority and for no other purpose.

1. A method of providing location-based advertisements, comprising:
defining boundaries for a market area around a location;
adjusting the boundaries of the market area according to at least one consumer consideration; and
providing targeted information limited to the adjusted market area.

2. The method of providing location-based advertisements in claim 1, further comprising:
limiting the market area to encompass only one consumer consideration; and
providing targeted information directed to needs associated to the selected consumer consideration.

3. The method of providing location-based advertisements in claim 1, wherein the targeted information includes information on merchants and manufacturers within the adjusted market area.

4. The method of providing location-based advertisements in claim 1, wherein the targeted information includes information on charitable causes impacting the adjusted market area.

5. The method of providing location-based advertisements in claim 1, wherein the at least one consumer consideration includes at least one of educational institutions, employers, retail centers, nearby population centers and available transportation.

6. A method of promoting sale of goods and services from merchants and manufacturers and charitable giving to charitable causes by linking a promotion with a charitable gift into a single transaction, wherein the merchants, manufacturers, and charitable causes are located within a single market area, comprising:
defining boundaries for the single market area according to at least one consumer consideration;
providing a web-accessible list of a plurality of merchants and manufacturers whose offers are accepted locally or are located within the single market area;
receiving a selection of at least one of the plurality of merchants and manufacturers from the list of merchants and manufactures;
displaying at least one promotion corresponding to the selected merchant or manufacturer and qualifying for a charitable donation;
receiving a selection of at least one promotion corresponding to the selected merchant or manufacturer;
providing a web-accessible list of a plurality of charitable causes located within the single market area;
receiving a selection of at least one of the plurality of charitable causes from the list of charitable causes;
providing a offer indicating the selected promotion and selected charitable cause, wherein the offer is redeemable at the selected merchant or manufacturer to obtain the selected promotion; and
tracking redemption of the offer at the selected merchant or manufacturer, wherein redemption of the offer triggers the charitable donation to the charitable cause.

7. The method of claim 6, wherein the method further comprises:
displaying a plurality of promotion corresponding to the selected merchant or manufacturer, wherein at least one promotion qualifies for a charitable donation; and
determining whether the selected promotion qualifies for a charitable donation before providing the web-accessible list of a plurality of charitable causes located within the single market area.

8. The method of claim 6, wherein a plurality of coupons for the selected promotion must be redeemed before the charitable donation is triggered.

9. The method of claim 8, further comprising tracking redemption of the plurality of offers and triggering the charitable donation when the usage of coupons exceeds a predetermined threshold.

10. The method of claim 6, further comprising providing a report to the selected merchant detailing the tracked redemption of offers for the selected promotion, wherein the report includes at least one information item including date and time, redemption location, consumer information, selected promotion, selected charitable cause and combinations thereof.

11. The method of claim 6, further comprising defining a plurality of market areas each having a corresponding list of merchants, manufacturers and charitable causes located within each market area.

12. The method of claim 11, further comprising:
providing a web-accessible list of the plurality of market areas;
receiving a selection of the most relevant market area, wherein the provided list of selected merchant or manufacturer and the selected list of charitable causes correspond to the selected market area.

13. The method of claim 6, wherein the at least one consumer consideration includes at least one of educational institutions, employers, retail centers, nearby population centers and available transportation.

14. A method of generating funding for charitable causes located within a predetermined market area, comprising:
defining a plurality of market areas each having a corresponding list of merchants, manufacturers and charitable causes located within each market area;
providing a web-accessible list of the plurality of market areas;
receiving a selection of the most relevant market area;
providing a unique code providing access to a list of merchants, manufacturers and charitable causes within the selected market area;
receiving a selection of at least one merchant or manufacturer and a selection of at least one charitable cause;
displaying at least one promotion corresponding to the selected merchant or manufacturer;
receiving a selection of at least one promotion corresponding to the selected merchant or manufacturer;
linking the selected promotion with the at least one selected charitable cause, wherein redemption of the promotion triggers a charitable donation to the selected charitable cause.

15. The method of generating funding for charitable causes in claim 14, further comprising:
providing a offer indicating the selected promotion and selected charitable cause, wherein the offer is redeemable at the selected merchant or manufacturer to obtain the selected promotion and trigger the charitable donation to the selected cause.

16. The method of generating funding for charitable causes in claim 15, further comprising:
tracking redemption of the offer at the selected merchant or manufacturer;
providing a report to the selected merchant detailing the tracked redemption of coupons for the selected promotion, wherein the report includes at least one information item including date and time, redemption location, consumer information, selected promotion, selected charitable cause and combinations thereof.

17. The method of generating funding for charitable causes in claim 14, further comprising:
providing a plurality of coupons corresponding to the selected promotion and selected charitable causes, wherein the offers are redeemable at the selected merchant or manufacturer to obtain the selected promotion and trigger the charitable donation to the selected cause;
distributing the plurality of coupons to encourage usage of the offers at the selected merchant or manufacturer and disbursement of the charitable donation to the selected cause.

18. The method of generating funding for charitable causes in claim 17, further comprising tracking redemption of the plurality of offers and triggering the charitable donation when the usage of coupons exceeds a predetermined threshold.

19. The method of generating funding for charitable causes in claim 13, further comprising:
receiving a use condition from the merchant or manufacturer that defines how and when the promotion can be used; and
limiting the display of the promotion until the use condition is satisfied.

20. A method of generating funding for charitable causes located within a predetermined market area, comprising:
providing a transferable marketing artifact having a unique code, wherein the unique code grants access to a web-accessible list of predefined market areas, wherein transfer of the marketing artifact corresponds to a charitable donation to a predefined charitable cause;
receiving a selection of the most relevant market area;
providing a web-accessible list of a plurality of merchants and manufacturers whose offers are accepted locally or are located within the selected market area.
